(19) United States
(12) Patent Application Publication
(10) Pub. No.: US 2025/0060703 A1
(43) Pub. Date: Feb. 20, 2025

(54) HOLOGRAM RECORDING SYSTEM AND METHOD

(71) Applicant: ams International AG, Jona (CH)

(72) Inventors: Robin Kaech, Ecublens (CH); Frédéric Montfort, Froideville (CH); Carlos Macias, Pully (CH); Marie Aubry, Echichens (CH)

(21) Appl. No.: 18/722,841

(22) PCT Filed: Nov. 14, 2022
(86) PCT No.: PCT/EP2022/081725

§ 371 Date: Jun. 21, 2024

(30) Foreign Application Priority Data
Dec. 22, 2021 (GB) 2118856.0

(51) Int. Cl. G03H 1/04

(52) U.S. Cl. CPC G03H 1/0465; G03H 1/041; G03H 2001/0419; G03H 2001/0473

(57) ABSTRACT

In an embodiment a hologram recording system includes an optical system configured to provide first and second beams of electromagnetic radiation, the optical system having a first lens configured to interact with the first beam, a photosensitive recording medium configured to receive the first and second beams and record an interference pattern formed by the first and second beams and an actuation system configured to move a component of the optical system to adjust a position of the first beam relative to the first lens and thereby control an angle of incidence of the first beam at the photosensitive recording medium, wherein the first lens is configured to interact with the second beam, and wherein the actuation system is configured to move a second component of the optical system to adjust a position of the second beam relative to the first lens and thereby control an angle of incidence of the second beam at the photosensitive recording medium.

### CROSS-REFERENCE TO RELATED APPLICATIONS

This patent application is a national phase filing under section 371 of PCT/EP2022/081725, filed Nov. 14, 2022, which claims the priority of British patent application 2118856.0, filed Dec. 22, 2021, each of which is incorporated herein by reference in its entirety.

### TECHNICAL FIELD

The disclosure relates to a hologram recording system and method, particularly but not exclusively, for recording freeform holograms.

### BACKGROUND

The present disclosure relates to a hologram recording system and method, which may be used to record freeform holograms. Freeform optics are highly sought after for their ability to compensate optical aberrations and to improve the design and overall compactness of optical systems. Due to their flat form factor, freeform holograms have the potential to further improve this compactness. Theoretically, holograms can be recorded to reconstruct any arbitrarily complex wavefront from any other arbitrary wavefront illumination. In practice however, one must first produce said wavefront as part of the hologram recording, which considerably complicates the task. That is, to record such a hologram, one needs first to produce the targeted freeform wavefront.

Known systems and methods of producing a targeted wavefront involve the use of expensive freeform lenses and/or diffractive elements, or involve designing a complex optical system consisting of traditional optical elements.

Known hologram recording systems and methods are inflexible in use. For example, known hologram recording systems and methods do not offer adjustments in recording resolution or speeds. As another example, known hologram recording systems and methods are capable of recording either transmission holograms or reflection holograms, not both.

It is therefore an aim of the present disclosure to provide a hologram recording system and method that addresses one or more of the problems above or at least provides a useful alternative.

### SUMMARY

In general, this disclosure proposes to overcome the above problems by using mechanical motion of an optical component of a hologram recording system to steer a beam of electromagnetic radiation about a back focal plane of a recording lens.

The present disclosure demonstrates a hologram recording system and method capable of fabricating freeform holograms with complex optical functions. The present disclosure proposes a simple hologram recording system capable of producing arbitrarily complex holograms by sequentially recording individual holographic elements.

According to one aspect of the present disclosure, there is provided a hologram recording system comprising an optical system configured to provide first and second beams of electromagnetic radiation. The optical system comprises a first lens configured to interact with the first beam. The hologram recording system comprises a photosensitive recording medium configured to receive the first and second beams and record an interference pattern formed by the first and second beams. The hologram recording system comprises an actuation system configured to move a component of the optical system to adjust a position of the first beam relative to the first lens and thereby control an angle of incidence of the first beam at the photosensitive recording medium.

Existing holographic recording systems typically rely on spatial light modulators to control the angle of incidence and overall optical function of the first beam about a predefined tilt. Overreliance on spatial light modulators may result in several drawbacks. For example, using a spatial light modulator may result in unwanted diffraction orders being recorded in the hologram. As another example, due to the diffractive nature of spatial light modulators, known hologram recording systems require the use of different projection patterns to perform wavelength multiplexing, which greatly complicates the hologram recording process. As a yet further example, the maximum extent of beam steering possible using a spatial light modulator is limited by a pixel size of the spatial light modulator (which is typically only a few microns). Depending on the wavelength of the electromagnetic radiation being used to record the hologram, this typically amounts to a maximum of a few degrees of angle of incidence control of the electromagnetic radiation at a photosensitive recording medium. Known hologram recording systems therefore require the use of a demagnification system to reach the required extent of beam steering, which can be expensive, bulky and add complexity to the hologram recording process.

The hologram recording system of the present disclosure does not rely upon the use of a spatial light modulator when recording a discontinuous first order approximation of an optical function, and therefore may avoid the abovementioned drawbacks associated with spatial light modulators when less complex recordings are desired.

The hologram recording system of the present disclosure does not rely upon diffraction to control the angle of incidence of the first beam and so therefore does not require the use of different projection patterns to achieve wavelength multiplexing. That is, the hologram recording system of the present disclosure offers a simplified and more flexible solution compared to known hologram recording systems.

The hologram recording system of the present disclosure controls angle of incidence through mechanical motion provided by the actuation system. This advantageously greatly increases the maximum extent of beam steering possible compared to known hologram recording systems. Very large beam steering angles may be reached by using high numerical aperture lenses/microscope objectives for the first lens. The hologram recording system of the present disclosure may reach numerical aperture values of more than 1.0 values by using index matching fluid (i.e. total internal reflection) recording.

The hologram recording system of the present disclosure advantageously allows control of a tilt angle (i.e. an angle of incidence) of the first beam on the photosensitive recording medium.

The actuation system may be configured to steer the first beam about a back focal plane of the first lens.

The hologram recording system may be arranged in a Mach-Zehnder interferometer arrangement.

The photosensitive recording medium may be located at a focal plane of the first lens.

The optical system may comprise a first optical device configured to output the first beam. The actuation system may be configured to move the first optical device to adjust the position of the first beam relative to the first lens and thereby control the angle of incidence of the first beam at the photosensitive recording medium.

Moving the optical device advantageously provides a convenient and flexible way of controlling an angle of incidence of the first beam at the photosensitive recording medium. This in turn provides a simple and inexpensive way of recording holograms comprising wavefronts on the photosensitive recording medium.

The first optical device may be movable along two perpendicular axes. The first optical device may be movable along three perpendicular axes.

The first lens may be configured to interact with the second beam. The actuation system may be configured to move a second component of the optical system to adjust a position of the second beam relative to the first lens and thereby control an angle of incidence of the second beam at the photosensitive recording medium.

Steering both the first beam and the second beam with respect to the first lens advantageously allows more complex wavefronts to be recorded at the photosensitive recording medium.

The optical system may comprise a second optical device configured to output the second beam. The actuation system may be configured to move the second optical device to adjust the position of the second beam relative to the first lens and thereby control the angle of incidence of the second beam at the photosensitive recording medium.

Moving the optical device advantageously provides a convenient and flexible way of controlling an angle of incidence of the second beam at the photosensitive recording medium. This in turn provides a simple and inexpensive way of recording holograms comprising wavefronts on the photosensitive recording medium.

The second optical device may be movable along two perpendicular axes. The two perpendicular axis may be substantially perpendicular to an optical axis of the second optical system. The second optical device may be movable along three perpendicular axes.

The optical system may comprise a beam splitter configured to receive the first beam from the first optical device. The beam splitter may be configured to transmit the first beam towards the first lens. The beam splitter may be configured to receive the second beam from the second optical device. The beam splitter may be configured to reflect the second beam towards the first lens. The actuation system may be configured to move the beam splitter to adjust the position of the second beam relative to the first lens and thereby control the angle of incidence of the second beam at the photosensitive recording medium.

The optical system may comprise a second lens configured to interact with the second beam. The photosensitive recording medium may be positioned between the first lens and the second lens.

This arrangement advantageously allows reflection hologram recording and transmission hologram recording to be performed by a single hologram recording system.

The second optical element may be a mirror configured to reflect the second beam towards the second lens.

The photosensitive recording medium may be located at a shared focal plane of the first lens and the second lens.

The optical system may comprise a second optical device configured to output the second beam. The actuation system may be configured to move the second optical device to adjust the position of the second beam relative to the second lens and thereby control the angle of incidence of the second beam at the photosensitive recording medium.

The optical system may be configured to converge or diverge at least one of the first and second beams towards the photosensitive recording medium and thereby illuminate the photosensitive recording medium across a plurality of angles.

This arrangement advantageously allows the recording of angle-multiplexed holograms (i.e. multiple holograms associated with each angle of incidence of the converging or diverging beam).

This arrangement advantageously allows the recording of holograms that diffuse incident light.

This arrangement advantageously allows the recording of holograms corresponding to spherical wavefronts.

The optical system may comprise a first optical device configured to output the first beam. The optical system may comprise a second optical device configured to output the second beam. The optical system may comprise a beam splitter configured to receive the first beam from the first optical device and transmit the first beam towards the first lens. The optical system may comprise a second lens configured to interact with the second beam. The optical system may comprise a mirror. The photosensitive recording medium may be positioned between the first lens and the second lens. The actuation system may be configured to move the second optical device between a transmissive hologram recording configuration in which the beam splitter reflects the second beam towards the first lens, and a reflective hologram recording configuration in which the mirror reflects the second beam towards the second lens.

The hologram recording system of the present disclosure can dynamically switch between reflection and transmission hologram recording on a single photosensitive recording medium. This advantageously allows a single hologram recording system to record in both transmission mode and reflection mode, thereby increasing a flexibility of the hologram recording system without needing to add any further optical devices.

The actuation system may be configured to move the beam splitter out of a beam path of the first beam when the second optical device is in the reflective hologram recording configuration.

Moving the beam splitter out of the beam path of the first beam advantageously saves light thereby improving an efficiency of the hologram recording system, and equalizes the optical powers of the first and second beams, when in the reflection configuration.

The actuation system may be configured to move the photosensitive recording medium relative to the first and second beams such that the hologram recording system is configured to record a plurality of individual hologram elements on different portions of the photosensitive recording medium.

Moving the photosensitive recording medium advantageously allows different portions of the photosensitive recording medium to receive different interference patterns formed by the first and second beams. In this way, individual hologram elements may be recorded at different portions of the photosensitive recording medium, and a complex hologram can be constructed one individual hologram element at a time. The individual hologram elements may be relatively simple compared to the complex hologram that they combine to form.

The hologram recording system may comprise a controller. The controller may be configured to receive a wavefront. The controller may be configured to control the actuation system such that the plurality of individual hologram elements form a hologram of the wavefront.

The plurality of individual hologram elements may form a complex wavefront.

The wavefront may be a freeform wavefront.

The hologram rearing system of the present disclosure advantageously constructs complex freeform wavefront holograms by constructing a plurality of simpler individual hologram elements. This advantageously allows the recording of freeform wavefronts without the need for expensive freeform optics.

The hologram recording system may comprise first and second apertures having variable sizes. The first and second apertures may be configured to selectively block at least some of the first and second beams and thereby control a size of the individual hologram elements.

Controlling a size of the individual hologram elements advantageously increases a flexibility of the hologram recording system. For example, decreasing the aperture size decreases a size of the hologram elements, and thereby increases a resolution of the hologram recording system. As another example, increasing the aperture size increases the size of the hologram elements, thereby allowing a faster recording of a hologram.

The first beam and the second beam may comprise a plurality of different wavelengths of electromagnetic radiation such that hologram recording system is configured to perform wavelength-multiplexed recording of holograms on the photosensitive recording medium.

Using multiple wavelengths advantageously allows multiple wavelength-multiplexed (or colour-multiplexed) holograms to be recorded on a single photosensitive recording medium.

The hologram recording system may comprise an optical fiber configured to transmit the first and second beams from an electromagnetic radiation source to the optical system.

Using optical fibers advantageously increases a physical flexibility of the hologram recoding system. For example, the first and second optical devices may be moved in a greater number of directions.

The first and second optical devices may each comprise a periscope system configured to receive the first and second beams.

The periscopes systems advantageously increase a stability of the power of the first and second beams compared to other systems (e.g. optical fibers) whilst still allowing movement of the first and second beams.

The hologram recording system may comprise an immersion fluid configured to increase a numerical aperture of the first lens.

A maximum angle of incidence (or tilt angle) of the first beam at the photosensitive recording medium may be at least partially defined by the numerical aperture of the first lens. Increasing the numerical aperture of the first lens advantageously increases a maximum angle of incidence achievable at the photosensitive recording medium, thereby increasing a variety of holograms that may be recorded by the hologram recording system.

The optical system may comprise a spatial light modulator configured to interact with at least one of the first and second beams.

The spatial light modulator advantageously allows the creation of more complex wave fronts.

The spatial light modulator advantageously improves discretization of individual hologram elements. That is, edges of the individual hologram elements can be fine-tuned, allowing for the recording of more accurate wavefronts.

The spatial light modulator may be configured to diffract incident electromagnetic radiation. The optical system may comprise a filtering aperture configured to selectively block at least some electromagnetic radiation diffracted by the spatial light modulator.

Use of the filtering aperture advantageously prevents unwanted diffraction orders from being recorded by the hologram recording system.

The optical system may be configured to provide a third beam of electromagnetic radiation. The first lens may be configured to interact with the third beam. The photosensitive recording medium may be configured to receive the third beam and record an interference pattern formed by the third beam and at least one of the first beam and the second beam. The actuation system may be configured to move a second component of the optical system to adjust a position of the third beam relative to the first lens and thereby control an angle of incidence of the third beam at the photosensitive recording medium. The first beam may comprise a first wavelength of electromagnetic radiation. The third beam may comprise a second wavelength of electromagnetic radiation. The second beam may comprise the first and second wavelengths of electromagnetic radiation, such that the hologram recording system is configured to perform simultaneous wavelength-multiplexed recording of holograms on the photosensitive recording medium.

The optical system may be configured to provide a third beam of electromagnetic radiation. The first lens may be configured to interact with the third beam. The photosensitive recording medium may be configured to receive the third beam and record an interference pattern formed by the third beam and at least one of the first beam and the second beam. The actuation system may be configured to move a second component of the optical system to adjust a position of the third beam relative to the first lens and thereby control an angle of incidence of the third beam at the photosensitive recording medium. The first, second and third beams may comprise a first wavelength of electromagnetic radiation. The actuation system may be configured to introduce a difference between the angle of incidence of the first beam and the angle of incidence of the third beam such that the hologram recording system is configured to perform simultaneous angular-multiplexed recording of holograms on the photosensitive recording medium

Recording a hologram using three beams having at least two different angles of incidence advantageously allows multiple holograms to be recorded at a single position on the photosensitive recording medium, with each hologram being associated with a different angle of incidence. For example, when illuminating the recorded hologram, a first wavefront may be produced when illuminating the recorded hologram with light having a first angle of incidence, and a second wavefront may be produced from the same location on the recorded hologram when illuminating the recorded hologram with light having a different angle of incidence. Such angular-multiplexing of recorded holograms advantageously increases the number of wavefronts that may be recorded on the hologram. This may be combined with wavelength-multiplexing to further tailor the wavefronts that may be produced from a single recorded hologram.

The optical system may comprise a master hologram recording configured to receive the first beam and diffract the first beam to form the second beam.

The hologram recording system may comprise a controller configured to control the actuation system to adjust the position of the first beam relative to the first lens and thereby control a local Bragg condition in a recorded hologram.

According to a second aspect of this disclosure, there is provided a method of recording a hologram comprising using an optical system to provide first and second beams of electromagnetic radiation. The method comprises using a first lens of the optical system to interact with the first beam. The method comprises receiving the first and second beams at a photosensitive recording medium. The method comprises controlling an angle of incidence of the first beam at the photosensitive medium by moving a component of the optical system to adjust a position of the first beam relative to the first lens. The method comprises recording an interference pattern formed by the first and second beams at the photosensitive recording medium.

The method may comprise using a first optical device to output the first beam. The method may comprise moving the first optical device to adjust the position of the first beam relative to the first lens and thereby control the angle of incidence of the first beam at the photosensitive recording medium.

The method may comprise using the first lens to interact with the second beam. The method may comprise moving a second component of the optical system to adjust a position of the second beam relative to the first lens and thereby control an angle of incidence of the second beam at the photosensitive recording medium.

The method may comprise using a second optical device to output the second beam. The method may comprise moving the second optical device to adjust the position of the second beam relative to the first lens and thereby control the angle of incidence of the second beam at the photosensitive recording medium.

The method may comprise using a beam splitter to receive the first beam from the first optical device, transmit the first beam towards the first lens, receive the second beam from the second optical device and reflect the second beam towards the first lens. The method may comprise moving the beam splitter to adjust the position of the second beam relative to the first lens and thereby control the angle of incidence of the second beam at the photosensitive recording medium.

The method may comprise using a second lens to interact with the second beam. The method may comprise positioning the photosensitive recording medium between the first and second lenses.

The method may comprise using a second optical device to output the second beam. The method may comprise moving the second optical device to adjust the position of the second beam relative to the second lens and thereby control the angle of incidence of the second beam at the photosensitive recording medium.

The method may comprise converging or diverging at least one of the first and second beams towards the photosensitive recording medium and thereby illuminating the photosensitive recording medium across a plurality of angles.

The method may comprise using a first optical device to output the first beam. The method may comprise using a second optical device to output the second beam. The method may comprise using a beam splitter to receive the first beam from the first optical device and transmit the first beam towards the first lens. The method may comprise using a second lens to interact with the second beam. The method may comprise providing a mirror. The method may comprise positioning the photosensitive recording medium between the first lens and the second lens. The method may comprise moving the second optical device between a transmissive hologram recording configuration in which the beam splitter reflects the second beam towards the first lens, and a reflective hologram recording configuration in which the mirror reflects the second beam towards the second lens.

The method may comprise moving the beam splitter out of a beam path of the first beam when the second optical device is in the reflective hologram recording configuration.

The method may comprise moving the photosensitive recording medium relative to the first and second beams to record a plurality of individual hologram elements on different portions of the photosensitive recording medium.

The method may comprise receiving a wavefront and moving the first beam relative to the first lens such that the plurality of individual hologram elements form a hologram of the wavefront. The wavefront may be a freeform wavefront.

The method may comprise controlling a size of the individual hologram elements.

The method may comprise using a plurality of different wavelengths to form the first and second beams and performing wavelength-multiplexed recording of holograms.

The method may comprise using an optical fiber to transmit the first and second beams.

The method may comprise using periscopes systems to receive the first and second beams.

The method may comprise using an immersion fluid to increase a numerical aperture of the first lens.

The method may comprise using a spatial light modulator to interact with at least one of the first and second beams.

The method may comprise diffracting incident electromagnetic radiation using the spatial light modulator. The method may comprise using a filtering aperture to selectively block at least some electromagnetic radiation diffracted by the spatial light modulator.

The method may comprise providing a third beam of electromagnetic radiation. The method may comprise using the first lens to interact with the third beam. The method may comprise using the photosensitive recording medium to receive the third beam and record an interference pattern formed by the third beam and at least one of the first beam and the second beam. The method may comprise moving a second component of the optical system to adjust a position of the third beam relative to the first lens and thereby control an angle of incidence of the third beam at the photosensitive recording medium. The first beam may comprise a first wavelength of electromagnetic radiation. The third beam may comprise a second wavelength of electromagnetic radiation. The second beam may comprise the first and second wavelengths of electromagnetic radiation to perform simultaneous wavelength-multiplexed recording of holograms on the photosensitive recording medium.

The method may comprise providing a third beam of electromagnetic radiation. The method may comprise using a first lens to interact with the third beam. The method may comprise using the photosensitive recording medium to receive the third beam and record an interference pattern formed by the third beam and at least one of the first beam and the second beam. The method may comprise moving a second component of the optical system to adjust a position of the third beam relative to the first lens and thereby control an angle of incidence of the third beam at the photosensitive recording medium. The first, second and third beams may comprise a first wavelength of electromagnetic radiation. The method may comprise introducing a difference between the angle of incidence of the first beam and the angle of incidence of the third beam to perform simultaneous angular-multiplexed recording of holograms on the photosensitive recording medium.

The method may comprise using a master hologram recording to receive the first beam and diffract the first beam to form the second beam.

The method may comprise adjusting the position of the first beam relative to the first lens and thereby controlling a local Bragg condition in a recorded hologram.

The present hologram recording system and method disclosed here utilises a novel approach at least in that mechanical motion of a component of an optical system is used to steer the first beam about a back focal plane of the first lens and thereby control an angle of incidence of the first beam at the photosensitive recording medium.

### BRIEF DESCRIPTION OF THE DRAWINGS

Some embodiments of the disclosure will now be described by way of example only and with reference to the accompanying drawings, in which:

FIG. 1 schematically depicts a hologram recording system in accordance with the present disclosure.

FIG. 2 schematically depicts the hologram recording system of FIG. 1 without the inclusion of first and second focusing lenses in the first and second optical devices in accordance with the present disclosure.

FIG. 3 schematically depicts the hologram recording system of FIG. 1 after the second optical device has been moved along a first direction in accordance with the present disclosure.

FIG. 4 schematically depicts the hologram recording system of FIG. 1 after the second optical device has been moved along a second direction in accordance with the present disclosure.

FIG. 5 schematically depicts the hologram recording system of FIG. 1 recording a first individual hologram element when the second optical element is in a transmissive hologram recording configuration in accordance with the present disclosure.

FIG. 6 schematically depicts the hologram recording system of FIG. 5 after the second optical device and the photosensitive recording medium have been moved by the actuation system in accordance with the present disclosure.

FIG. 7 schematically depicts the hologram recording system of FIG. 1 recording a third individual hologram element when the second optical element is in a reflective hologram recording configuration in accordance with the present disclosure.

FIG. 8 schematically depicts the hologram recording system of FIG. 7 after the second optical device and the photosensitive recording medium have been moved by the actuation system in accordance with the present disclosure.

FIG. 9 schematically depicts the hologram recording system of FIG. 1 arranged to perform wavelength-multiplexed recording of a hologram on the photosensitive recording medium using optical fibres in accordance with the present disclosure.

FIG. 10 schematically depicts the hologram recording system of FIG. 1 arranged to perform wavelength-multiplexed recording of a hologram on the photosensitive recording medium using first and second optical devices comprising periscope systems in accordance with the present disclosure.

FIG. 11 schematically depicts a view from the side of the first optical device of FIG. 10 comprising a periscope system in accordance with the present disclosure.

FIG. 12 schematically depicts a first optical device comprising a spatial light modulator in accordance with the present disclosure.

FIG. 13 schematically depicts a first optical device comprising a spatial light modulator and a periscope system in accordance with the present disclosure.

FIG. 14 schematically depicts the hologram recording system of FIG. 1 arranged to perform simultaneous angular-multiplexed and wavelength-multiplexed recording of holograms on the photosensitive recording medium in accordance with the present disclosure.

FIG. 15 schematically depicts the holographic recording system of FIG. 1 arranged to record holograms based on a reflective master hologram recording in accordance with the present disclosure.

FIG. 16 schematically depicts the holographic recording system of FIG. 1 arranged to record holograms based on a transmissive master hologram recording in accordance with the present disclosure.

FIG. 17 shows a flowchart of a method of recording a hologram in accordance with the present disclosure.

### DETAILED DESCRIPTION OF THE ILLUSTRATIVE EMBODIMENTS

Generally speaking, the disclosure provides a hologram recording system and method that control a tilt angle of a recording beam of radiation at a photosensitive recording medium by moving the beam of radiation with respect to a back focal plane of a recording lens.

Some examples of the solution are given in the accompanying figures. In the accompanying figures, like components are labelled with like reference numerals. Descriptions of similarities between like components will not be repeated for each figure to avoid unnecessary duplication.

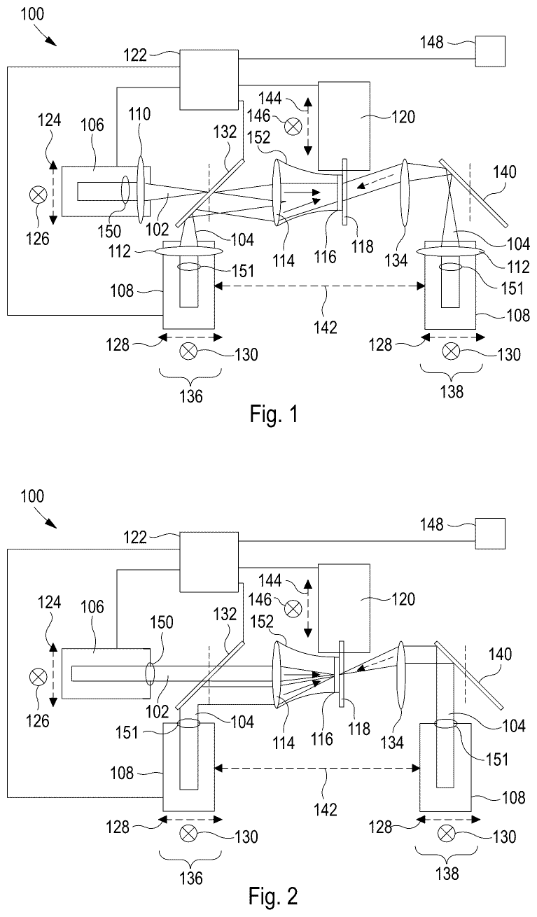

FIG. 1 schematically depicts a hologram recording system 100 according to an embodiment of the present disclosure. The hologram recording system 100 comprises an optical system configured to provide first and second beams 102, 104 of electromagnetic radiation. In the example of FIG. 1, the optical system comprises a first optical device 106 configured to output the first beam 102 and a second optical device 108 configured to output the second beam 104. The first and second beams 102, 104 may be provided to the first and second optical devices 106, 108 by an electromagnetic radiation source, such as a continuous-wave laser (not shown). A wavelength of electromagnetic radiation provided by the electromagnetic radiation source may be, for example, about 400 nm or more. A wavelength of electromagnetic radiation provided by the electromagnetic radiation source may be, for example, about 1500 nm or less. A power of electromagnetic radiation provided by the electromagnetic radiation source may, for example, range from less than 1 mW to more than 2000 mW. The wavelength and power of the first and second beams 102, 104 may be selected in at least partial dependence on a photosensitive recording medium 116 that is used within the hologram recording system 100.

In the example of FIG. 1, the first and second optical devices 106, 108 comprise first and second focusing lenses 110, 112 configured to focus the first and second beams 102, 104 respectively. The optical system further comprises a first lens 114 configured to interact with the first beam 102. The lenses 114 that form part of the hologram recording system 100 may be selected in at least partial dependence on a wavelength of the first and second beams 102, 104. For example, the lenses 114 may comprise coatings selected to improve a transmission of the first and second beams 102, 104. In the example of FIG. 1, the first lens 114 acts to collimate the first beam 102. The hologram recording system 100 further comprises a photosensitive recording medium 116 configured to receive the first and second beams 102, 104 and record an interference pattern formed by the first and second beams 102, 104. The photosensitive recording medium 116 may be formed of, for example, photopolymer, silver halide emulsion, photorefractive materials, etc. The photosensitive recording medium 116 is mounted to a support 118, and the support 118 is connected to a movable mount 120. The movable mount 120 may be formed of a material that is substantially transparent to the second beam 104, and may therefore be designed in at least dependence on a wavelength of the second beam 104.

The hologram recording system 100 comprises an actuation system 122 configured to move a component of the optical system to adjust a position of the first beam 102 relative to the first lens 114 and thereby control an angle of incidence of the first beam 102 at the photosensitive recording medium 116. Controlling the tilt angle of the first beam 102 at the photosensitive recording medium 116 allows control of the form of the hologram recorded at the photosensitive recording medium 116. In the example of FIG. 1, the actuation system 122 is configured to move the first optical device 106 to adjust the position of the first beam 102 relative to the first lens 114 and thereby control the angle of incidence of the first beam 102 at the photosensitive recording medium 116. In the example of FIG. 1, the first optical device 106 is movable along two perpendicular axes 124, 126. The two perpendicular axes 124, 126 are themselves orthogonal to a propagation direction of the first beam 102 output by the first optical device 106. In FIG. 1, the use of an “X” in a circle indicates that the axis 126 travels into and out of the plane of the figure. In the figures, parallel axes are provided with like reference numerals.

In the example of FIG. 1, the first lens 114 is configured to interact with the second beam 104, and the actuation system is configured to move a second component of the optical system to adjust a position of the second beam 104 relative to the first lens and thereby control an angle of incidence of the second beam 104 at the photosensitive recording medium 116. Controlling the tilt angle of the second beam 104 at the photosensitive recording medium 116 allows further control of the form of the hologram recorded at the photosensitive recording medium 116. In the example of FIG. 1, the actuation system is configured to move the second optical device 108 to adjust the position of the second beam 104 relative to the first lens 114 and thereby control the angle of incidence of the second beam 104 at the photosensitive recording medium 116. In the example of FIG. 1, the second optical device 108 is movable along two perpendicular axes 128, 130. The two perpendicular axes 128, 130 are themselves orthogonal to a propagation direction of the second beam 104 output by the second optical device 108. Steering both the first beam 102 and the second beam 104 advantageously allows more complex holograms (e.g. with two freeform wavefronts) to be recorded at the photosensitive recording medium 116.

In the example of FIG. 1, the optical system comprises a beam splitter 132. The beam splitter 132 may, for example, be a cube beam splitter, a plate beam splitter, a film beam splitter, etc. The beam splitter 132 is configured to receive the first beam 102 from the first optical device 106 and transmit the first beam 102 towards the first lens 114. The beam splitter 132 may reflect a portion (not shown) of the first beam 102. The reflected portion of the first beam may be directed towards a beam bump. The beam splitter 132 is configured to receive the second beam 104 from the second optical device 108 and reflect the second beam 104 towards the first lens 114. The beam splitter 132 may transmit a portion (not shown) of the second beam 104. The transmitted portion of the second beam 104 may be directed towards a beam dump (e.g. the same beam dump used to absorb the reflected portion of the first beam 102). In the example of FIG. 1, the actuation system 122 is configured to move the beam splitter 132. Moving the beam splitter 132 along one axis 128 may steer the second beam 104 in one dimension to adjust the position of the second beam 104 relative to the first lens 114 and thereby control the angle of incidence of the second beam 104 at the photosensitive recording medium 116. The beam splitter 132 is movable out of a propagation path of the first beam 102 as is described in more detail below.

In the example of FIG. 1, the optical system comprises a second lens 134 configured to interact with the second beam 104. The photosensitive recording medium 116 is positioned between the first lens 114 and the second lens 134. The photosensitive recording medium 116 may be located at a shared focal plane of the first lens 114 and the second lens 134.

In the example of FIG. 1, the actuation system 122 is configured to move the second optical device 108 between two configurations 136, 138. A first configuration is a transmissive hologram recording configuration 136 in which the beam splitter 132 reflects the second beam 104 towards the first lens 114. In the transmission configuration 136 the first lens 114 transmits both the first beam 102 and the second beam 104 to the photosensitive recording medium 116. A second configuration 138 is a reflective hologram recording configuration 138 in which a mirror 140 reflects the second beam 104 towards the second lens 134. The mirror 140 may be formed of, for example, a dielectric material, a metallic material, etc. The material of the second mirror 140 may be selected in at least partial dependence on a wavelength of the second beam 104. In the reflection configuration 138 the first lens 114 transmits the first beam 102 to the photosensitive recording medium 116 whereas the second lens 134 transmits the second beam 104 to the photosensitive recording medium 116. In the reflection configuration 138 the first and second beams 102, 104 are incident on opposing sides of the photosensitive recording medium 116. In the reflection configuration 138, the support 118 may be formed of a substantially transparent material to allow the second beam 104 to reach the photosensitive recording medium 116. A travel distance 142 of the second optical device 108 along one of the axis 128 may be greater than the other axis 130 to allow the actuation system 122 to move the second optical device 108 between the transmission recording configuration 136 and the reflection recording configuration 138. Having both configurations 136, 138 advantageously allows a single hologram recording system 100 to perform both reflection hologram recording and transmission hologram recording.

When the second optical device 108 is in the reflection recording configuration 138, the mirror 140 is configured to receive the second beam 104 from the second optical device 108 and reflect the second beam 104 towards the second lens 134. The actuation system 122 is configured to move the beam splitter 132 out of a beam path of the first beam 102 when the second optical device 108 is in the reflective hologram recording configuration 138 in order to reduce unnecessary losses of the first beam 102, and thereby improve an efficiency of the hologram recording system 100.

The actuation system 122 is configured to move the photosensitive recording medium 116 relative to the first and second beams 102, 104 such that the hologram recording system 100 is configured to record a plurality of individual hologram elements on different portions of the photosensitive recording medium 116. That is, different portions of the photosensitive recording medium 116 may receive different interference patterns formed by the first and second beams. In this way, individual hologram elements may be recorded at different portions of the photosensitive recording medium 116, and a more complex hologram may be constructed across the photosensitive recording medium 116 one individual hologram element at a time. The first and or second beams 102, 104 may be steered to different angles of incidence on the photosensitive recording medium 116 for different portions of the photosensitive recording medium 116 such that different hologram elements are formed at different positions on the photosensitive recording medium 116. In the example of FIG. 1 the photosensitive recording medium 116 is movable along two perpendicular axes 144, 146. The two perpendicular axes 144, 146 may be parallel to the two perpendicular axes 124, 126 of the first optical device 106.

The hologram recording system 100 comprises a controller 148 configured to receive a desired wavefront design and control the actuation system 122 such that the plurality of individual hologram elements recorded on the photosensitive recording medium 116 form a hologram of the wavefront. The sequence of individual hologram elements may form any arbitrarily complex wavefront, including a simple plane wave, spherical wavefronts, cylindrical wavefronts, wavefronts comprising optical aberrations and freeform wavefronts. A freeform wavefront may be understood as having a shape or shapes with little to no symmetry. Such wavefronts may be represented in the controller 148 using one or more input types such as, for example, Zernike polynomials, Jacobi polynomials, Cartesian polynomials, local phase gradients, etc. . . . This advantageously allows the construction of complex freeform wavefront holograms by constructing a series of simpler individual hologram elements and effectively stitching the hologram elements together by moving the photosensitive recording medium 116 between different illuminations using the first and second beams 102, 104.

In the example of FIG. 1, the hologram recording system 100 comprises apertures 150, 151 having variable sizes. The apertures 150, 151 are configured to selectively block at least some of the first beam 102 and the second beam 104 respectively, and thereby control a size of the individual hologram elements formed by the first beam 102 an the second beam 104 on the photosensitive recording medium 116. In the example of FIG. 1, a first aperture 150 forms part of the first optical device 106 and a second aperture 151 forms part of the second optical device 108. The apertures 150, 151 may be located elsewhere in the hologram recording system 100. Decreasing the aperture 150, 151 sizes decreases a size of the individual hologram elements formed on the photosensitive recording medium 116, and thereby increases a resolution of the hologram recording system 100. Increasing the aperture 150, 151 sizes increases the size of the individual hologram elements formed on the photosensitive recording medium 116, and thereby allows a faster recording of the hologram. This advantageously provides greater flexibility of use of the hologram recording system 100.

In the example of FIG. 1, the hologram recording system 100 comprises an immersion fluid 152 configured to increase a numerical aperture of the first lens 114. The immersion fluid 152 may be selected at least partially based on a refractive index of the first lens 114. The immersion fluid 152 may comprise, for example, water, oil, glycerine, or index matching liquids in general. A range of angles of incidence at the photosensitive recording medium 116 across which the first beam 102 may be controlled is at least partially defined by the numerical aperture of the first lens 114. As such, increasing the numerical aperture of the first lens 114 by using the immersion fluid 152 advantageously increases a maximum tilt angle of the first beam 102 that is achievable at the photosensitive recording medium 116, which in turn allows a greater range of wavefront holograms to be recorded. Immersion fluid may also be provided in a similar manner when the second optical device 108 is in the reflective hologram recording configuration 138 to increase a numerical aperture of the second lens 134.

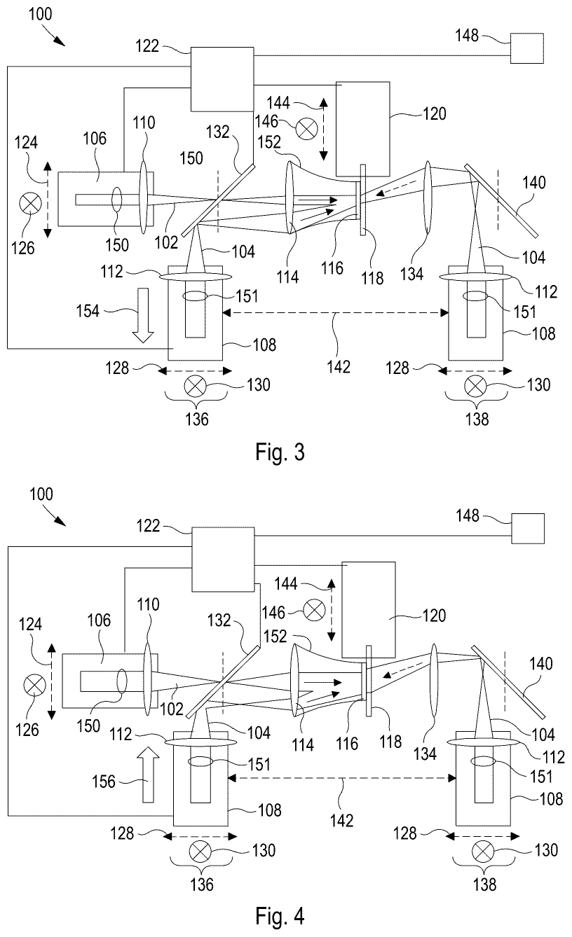

FIG. 2 schematically depicts the hologram recording system 100 of FIG. 1 without the inclusion of first and second focusing lenses in the first and second optical devices 136, 138. In the example of FIG. 2, both the first and second beams 102, 104 are collimated upon exiting their respective optical devices 106, 108. The first lens 114 (and the second lens 134 when in reflective recording configuration 138) are configured to focus the first and second beams 102, 104 towards the photosensitive recording medium 116. As such, the hologram recording system 100 of FIG. 2 is configured to record holograms using two focused beams 102, 104. In the example of FIG. 2, the recorded hologram may act more like a diffuser compared to that of FIG. 1. That is, illuminating the recorded hologram with a plane wave would diffract the illumination light into a conical beam. This may be understood as simultaneous angular multiplexing in which multiple holograms are simultaneously recorded, with each hologram corresponding to an angle of the conical beam. So this embodiment is targeted at producing a different type of holograms. Some applications require to control the cone angle of diffusion. By controlling the size of the apertures 150, 151 the hologram recording system 100 controls the range of angles under which the illumination light will be diffused. By incorporating one lens into the first or second optical device 106, 108 to form one collimated beam and adjusting a size of the corresponding aperture 150, 151, to reduce a size of the collimated beam, a similar effect may be achieved (similar to the arrangement of FIG. 3). In the example of FIG. 1, there is no diffusion. That is, at one point of the photosensitive recording medium 116, all of the illumination light may be diffracted in a single direction rather than undergoing diffusion as per FIG. 2.

FIG. 3 schematically depicts the hologram recording system 100 of FIG. 1 after the second optical device 108 has been moved along a first direction 154. In the example of FIG. 3 the second optical device 108 is movable along axis that is perpendicular to the two perpendicular axis 128, 130 of FIG. 1. In the example of FIG. 3, the actuation system 122 has moved the second optical device 108 in a first direction 154 to increase an electromagnetic radiation propagation distance between the second optical device 108 and the first lens 114 in the transmissive hologram recording configuration 136. The actuation system 122 is also capable of moving the second optical device 108 in the first direction 154 when the second optical device 108 is in the reflective hologram recording configuration 138 to increase an electromagnetic radiation propagation distance between the second optical device 108 and the second lens 134. By moving the second optical device 108 along the third axis, a focus spot of the second beam 104 is moved relative to the first lens 114 (i.e. a focal plane of the first lens 114), or relative to the second lens 134 when in the reflective hologram recording configuration 138. As shown in the example of FIG. 3, increasing the electromagnetic radiation propagation distance between the second optical device 108 and the focal plane of the first lens 114 results in a converging second beam 104 at the photosensitive recording medium 116. That is, a hologram may be recording using a planar first beam 102 and a converging second beam 104. By using a converging second beam (i.e. by defocusing the second beam 104 on a back focal plane of the first lens 114) a spherical optical function may be recorded as a hologram on the photosensitive medium 116 without requiring the use of a spatial light modulator.

FIG. 4 schematically depicts the hologram recording system 100 of FIG. 1 after the second optical device 108 has been moved along a second direction 156. In the example of FIG. 4 the second optical device 108 is movable along axis that is perpendicular to the two perpendicular axis 128, 130 of FIG. 1. In the example of FIG. 4, the actuation system 122 has moved the second optical device 108 in a second direction 156 to decrease an electromagnetic radiation propagation distance between the second optical device 108 and the first lens 114 in the transmissive hologram recording configuration 136. The actuation system 122 is also capable of moving the second optical device 108 in the second direction 156 when the second optical device 108 is in the reflective hologram recording configuration 138 to decrease an electromagnetic radiation propagation distance between the second optical device 108 and the second lens 134. By moving the second optical device 108 along the third axis, a focus spot of the second beam 104 is moved relative to the first lens 114 (i.e. a focal plane of the first lens 114), or relative to the second lens 134 when in the reflective hologram recording configuration 138. As shown in the example of FIG. 4, decreasing the electromagnetic radiation propagation distance between the second optical device 108 and the focal plane of the first lens 114 results in a diverging second beam 104 at the photosensitive recording medium 116. That is, a hologram may be recording using a planar first beam 102 and a diverging second beam 104. In a similar manner to FIG. 3, by using a diverging second beam (i.e. by defocusing the second beam 104 on a back focal plane of the first lens 114) a spherical optical function may be recorded as a hologram on the photosensitive medium 116 without requiring the use of a spatial light modulator.

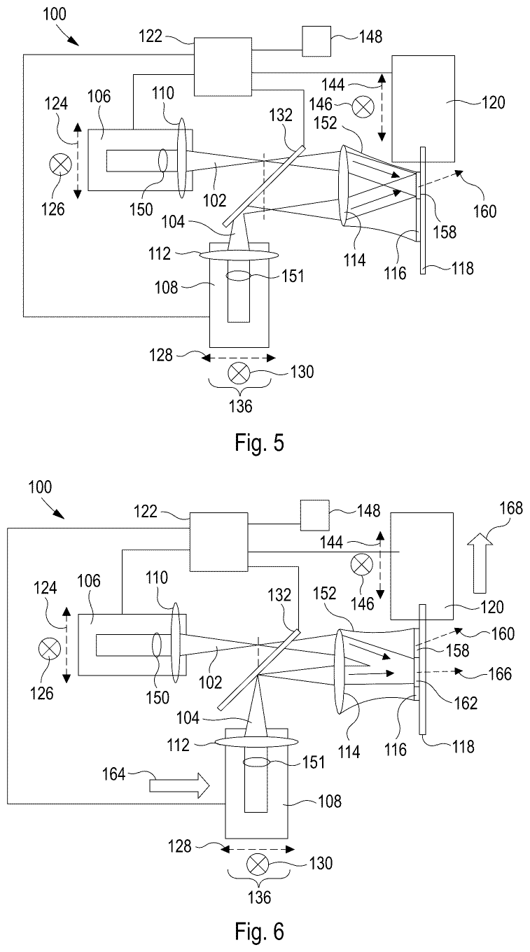

FIG. 5 schematically depicts the hologram recording system of FIG. 1 recording a first individual hologram element 158 when the second optical element 108 is in the transmissive hologram recording configuration 136. The positioning of the second optical device 108 and the beam splitter 132 in FIG. 5 result in the second beam 104 having a first tilt direction 160 (i.e. a first angle of incidence relative to the photosensitive recording medium 116). The positioning of the photosensitive recording medium 116 relative to the first and second beams 102, 104 results in a first individual hologram element 158 being recorded at a first portion of the photosensitive recording medium 116.

FIG. 6 schematically depicts the hologram recording system 100 of FIG. 5 after the second optical device 108 and the photosensitive recording medium 116 have been moved by the actuation system 122. The actuation system 122 has moved the photosensitive recording medium 116 in a fifth direction 168 relative to the first and second beams 102, 104 such that a second individual hologram element 162 is recorded on a second portion of the photosensitive recording medium 116. The actuation system 122 has also moved the second optical device 108 along an axis 128 in a fourth direction 164 such that a position of the second beam 104 relative to the first lens 114 is adjusted. This results in the second beam 104 having a second tilt direction 166 (i.e. a second angle of incidence relative to the photosensitive recording medium 116) that is different to the first tilt direction 160. As such, the second individual hologram element 162 recorded at the second portion of the photosensitive recording medium 116 is different to the first individual hologram element 158 recorded at the first portion of the photosensitive recording medium 116. In this way, the hologram recording system 100 can be used to record a plurality of individual hologram elements 158, 162 on different portions of the photosensitive recording medium 116 in the transmissive hologram recording configuration 136. The plurality of individual hologram elements 158, 162 may combine to form a more complex hologram (e.g. recording a series of simple wavefront holograms to create a more complex wavefront hologram overall).

In the examples of FIGS. 5 and 6, the first optical device 106 is kept stationary. Due to being stationary between different portions of the photosensitive recording medium 116, the first beam 102 may act as a plane wave reference beam, whilst the second beam 104 undergoes a change in tilt angle 160, 166 (i.e. angle of incidence) and thereby generates different interference patterns (corresponding to different individual hologram elements 158, 162) on the photosensitive recording medium 116. As previously discussed, it is also possible to use the actuation system 122 to move the first optical device 106 to adjust the position of the first beam 102 relative to the first lens 114 and thereby control the angle of incidence (or tilt angle) of the first beam 104 at the photosensitive recording medium 116. Adjusting a tilt direction (i.e. angles of incidence) of both the first beam 102 and the second beam 104 allows for the recording of more complex holograms, e.g. using two freeform wavefronts. Less complex holograms, e.g. using a single freeform wavefront, may be recorded whilst adjusting an angle of incidence of only one beam 102, 104 and keeping the other beam 102, 104 static.

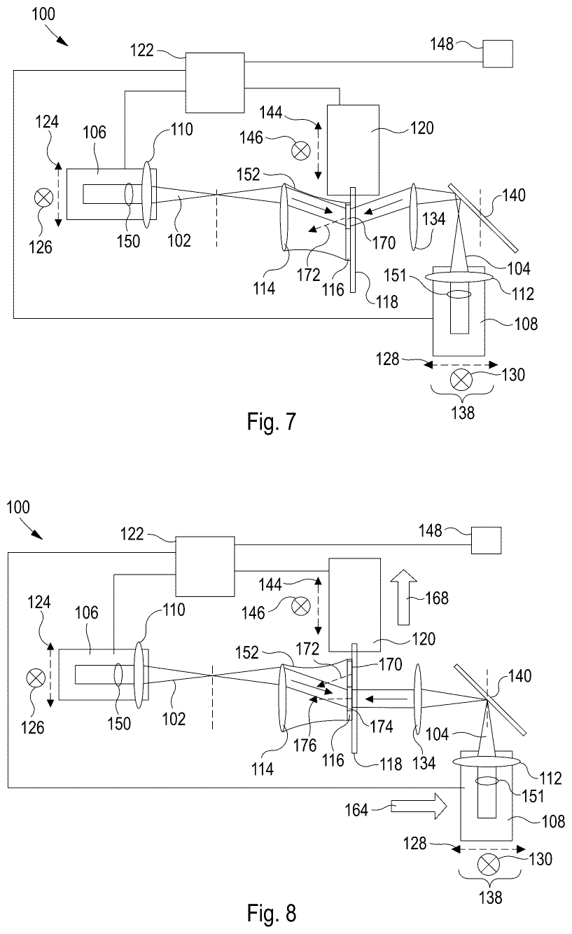

FIG. 7 schematically depicts the hologram recording system of FIG. 1 recording a third individual hologram element 170 when the second optical element 108 is in the reflective hologram recording configuration 138. The positioning of the second optical device 108 and the mirror 140 in FIG. 7 result in the second beam 104 having a third tilt direction 172 (i.e. a third angle of incidence relative to the photosensitive recording medium 116). The positioning of the photosensitive recording medium 116 relative to the first and second beams 102, 104 results in the third individual hologram element 170 being recorded at a first portion of the photosensitive recording medium 116.

FIG. 8 schematically depicts the hologram recording system 100 of FIG. 7 after the second optical device 108 and the photosensitive recording medium 116 have been moved by the actuation system 122. The actuation system 122 has moved the photosensitive recording medium 116 in the fifth direction 168 relative to the first and second beams 102, 104 such that a fourth individual hologram element 174 is recorded on a second portion of the photosensitive recording medium 116. The actuation system 122 has also moved the second optical device 108 along an axis 128 in the fourth direction 164 such that a position of the second beam 104 relative to the second lens 134 is adjusted. This results in the second beam 104 having a fourth tilt direction 176 (i.e. a second angle of incidence relative to the photosensitive recording medium 116) that is different to the third tilt direction 172. As such, the fourth individual hologram element 174 recorded at the second portion of the photosensitive recording medium 116 is different to the third individual hologram element 170 recorded at the first portion of the photosensitive recording medium 116. In this way, the hologram recording system 100 can be used to record a plurality of individual hologram elements 170, 174 on different portions of the photosensitive recording medium 116 in the reflective hologram recording configuration 138. The plurality of individual hologram elements 170, 174 may combine to form a more complex hologram (e.g. recording a series of simple wavefront holograms to create a more complex wavefront hologram overall).

In the examples of FIGS. 7 and 8, the first optical device 106 is kept stationary. Due to being stationary between different portions of the photosensitive recording medium 116, the first beam 102 may act as a plane wave reference beam, whilst the second beam 104 undergoes a change in tilt angle 172, 176 and thereby generates different interference patterns (corresponding to different individual hologram elements 170, 174) on the photosensitive recording medium 116. As previously discussed, it is also possible to use the actuation system 122 to move the first optical device 106 to adjust the position of the first beam 102 relative to the first lens 114 and thereby control the angle of incidence (or tilt angle) of the first beam 104 at the photosensitive recording medium 116.

Adjusting a tilt direction (i.e. angles of incidence) of both the first beam 102 and the second beam 104 allows for the recording of more complex holograms, e.g. using two freeform wavefronts. Less complex holograms, e.g. using a single freeform wavefront, may be recorded whilst adjusting an angle of incidence of only one beam 102, 104 and keeping the other beam 102, 104 static.

In the examples of FIGS. 5-8, the controller 148 may be configured to receive two wavefront designs, one for the first beam 102 and one for the second beam 104, and control the actuation system 122 such that the plurality of individual hologram elements 158, 162, 170, 174 form a hologram of the wavefronts. The input wavefront designs may be decomposed into constituent parts corresponding to different individual hologram elements by the controller 148, and may be represented using, for example Zernike polynomials, Jacobi polynomials, Cartesian polynomials, local phase gradients, etc. . . . The collection of individual hologram elements 158, 162, 170, 174 may form complex wavefronts, such as freeform wavefronts. Said wavefronts may combine both transmissive and reflective constituent parts (corresponding to individual hologram elements 158, 162, 170, 174) by operating the second optical device 108 in the transmissive and reflective hologram recording configurations 136, 138.

In the examples of FIGS. 5-8, the hologram recording system 100, comprises an aperture 150 having a variable size. As previously discussed, the aperture 150 is configured to selectively block at least some of the first beam 102 and thereby control a size of the individual hologram elements 158, 162, 170, 174 recorded on the photosensitive recording medium 116. Decreasing the aperture 150 size blocks more of the first beam 102 and decreases a size of the individual hologram elements 158, 162, 170, 174. This in turn increases a resolution of the hologram recording system 100 as smaller individual hologram elements 158, 162, 170, 174 may be recorded on the photosensitive recording medium 116. Increasing the aperture 150 size increases the size of the individual hologram elements 158, 162, 170, 174, thereby requiring fewer hologram elements to complete the total hologram and allowing a faster recording of the total hologram. The size of the aperture 150 may be controlled by the actuation system 122. The size of the aperture 150 may be selected based at least in part on a complexity of the hologram to be recorded. For example, a relatively simple hologram (e.g. a plane wavefront) may involve the use of fewer hologram elements, and therefore use a large aperture 150 size. On the other hand, a more complex hologram (e.g. a freeform wavefront) may involve the use of many smaller hologram elements, and therefore use a smaller aperture 150 size.

In the examples of FIGS. 7 and FIG. 8, the actuation system 122 has moved the beam splitter of FIG. 1 out of a beam path of the first beam 102 when the second optical device 108 is in the reflective hologram recording configuration 138. Removing the beam splitter advantageously retains more of the first beam 102 and equalises intensities of the first and second beams 102, 104, thereby improving an efficiency of the hologram recording system 100 when in the reflective recording configuration 138.

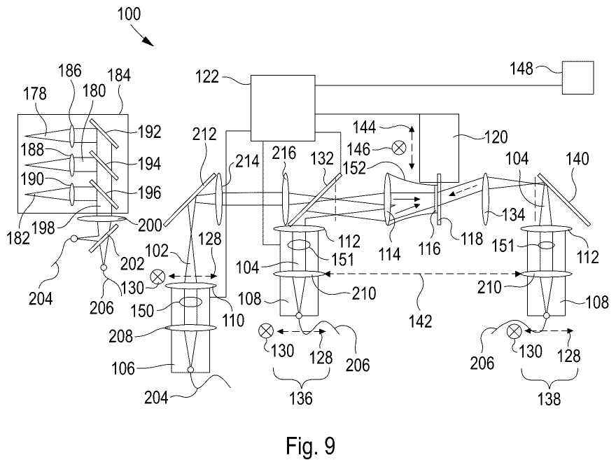

FIG. 9 schematically depicts the hologram recording system 100 of FIG. 1 arranged to perform wavelength-multiplexed recording of a hologram on the photosensitive recording medium 116 using optical fibres 204, 206. The first beam 102 and the second beam 104 comprise a plurality of different wavelengths of electromagnetic radiation. In the example of FIG. 9, the first and second beams 102, 104 each comprise three different wavelengths 178, 180, 182 of electromagnetic radiation. The wavelengths 178, 180, 182 of electromagnetic radiation may be selected in at least partial dependence on a wavelength response range of the photosensitive recording medium 116. The first and second beams 102, 104 may comprise a greater or lesser number of different wavelengths 178, 180, 182 of electromagnetic radiation. Multiplexing of the different wavelengths 178, 180, 182 advantageously allows colour-multiplexed holograms to be recorded on the single photosensitive recording medium 116. That is, the same optical function is recorded at different wavelengths. Furthermore, wavelength-multiplexed recording of a hologram may be performed at once (i.e. simultaneously recording using different wavelengths) without the use of a spatial light modulator.

In the example of FIG. 9, the hologram recording system 100 comprises a laser combiner 184 configured to form the first and second beams 102, 104. The laser combiner 184 comprises three pairs of lenses 186, 188, 190 and mirrors 192, 194, 196. Each pair of lenses 186, 188, 190 and mirrors 192, 194, 196 is configured to interact with one of the three different wavelengths 178, 180, 182. The second mirror 194 may be substantially transparent to the first wavelength 178 and the third mirror may be substantially transparent to both the first and second wavelengths 178, 180. Upon exiting the laser combiner 184 a combined beam 198 is focussed by a lens 200 towards a beam splitter 202. The beam splitter 202 splits the combined beam 198 between two optical fibres 204, 206. The laser combiner 184 may be utilised in any given embodiment (e.g. the systems of FIGS. 1-8). The laser combiner 184 is provided merely as an example of a source of multiple wavelengths of electromagnetic radiation. Other types of electromagnetic radiation source may be used such as, for example, a tuneable laser.

A first optical fiber 204 is connected to the first optical device 106 and transmits the combined beam 198 from the laser combiner 184 to the first optical device 106. A second optical fibre 206 is connected to the second optical device 108 and transmits the combined beam 198 from the laser combiner 184 to the second optical device 108. In the example of FIG. 9 only the ends of each optical fiber 204, 206 are shown to avoid unnecessary complexity and ease understanding of the figure. The use of optical fibers 204, 206 advantageously increases an overall flexibility of the hologram recording system 100 compared to other arrangements (such as the periscope systems discussed later), allowing parts to be repositioned and/or reoriented as desired. For example, the first optical device 106 may be arranged parallel to the second optical device 108, as is the case in FIG. 9, rather than perpendicular, as is the case in FIG. 1.

The first and second optical devices fourth and fifth lenses 208, 210. The fourth and fifth lenses 208, 210 are configured to receive a diverging combined beam 198 from the optical fibres 204, 206 and collimate the combined beams 198. The collimated combined beams 198 are then incident on lenses 110, 112 which focus the collimated combined beams 198 and output the first and second beams 102, 104. The fourth and fifth lenses 208, 210 are present in previous embodiments 208, 210 but have been omitted from previous figures (along with a light source such as the laser combiner) in order to simplify the earlier figures and allow the earlier figures to focus on the core concept of the present disclosure.

The optical system of the hologram recording system 100 of FIG. 9 comprises further optical components compared to FIG. 1. The optical system comprises a second mirror 212 configured to receive the first beam 102 from the first optical device 106 and reflect the first beam 102 towards a sixth lens 214. The sixth lens 214 is configured to collimate the first beam 201 and direct the collimated first beam 102 toward an seventh lens 216. The seventh lens 216 is configured to focus the collimated first beam 102 through the beam splitter 132 and towards the first lens 114. The mirror 212 and the lenses 214, 216 are not essential, and are only added to form relays to account for space constraints in practice (e.g. to avoid collisions between the first and second optical devices 106, 108).

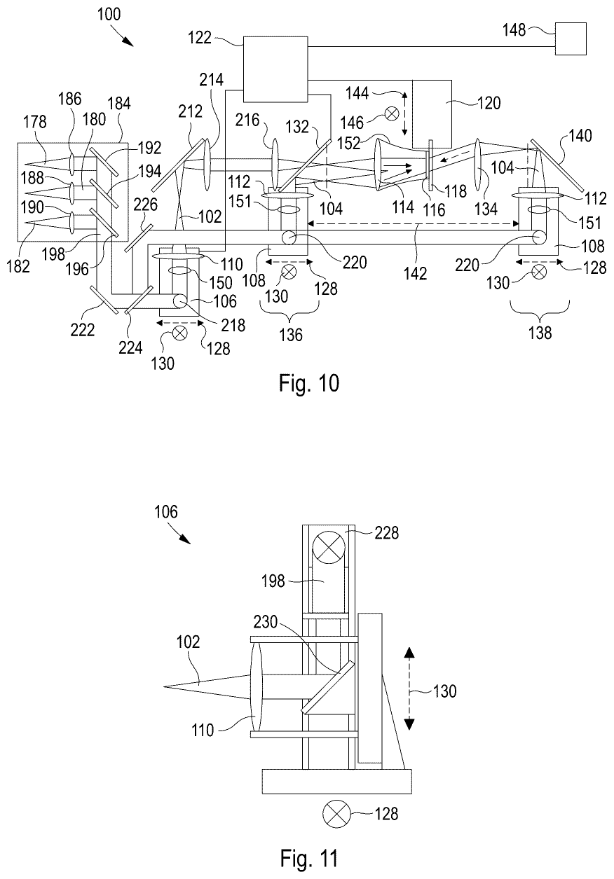

FIG. 10 schematically depicts the hologram recording system 100 of FIG. 1 arranged to perform wavelength-multiplexed recording of a hologram on the photosensitive recording medium 116 using first and second optical devices 106, 108 comprising periscope systems 218, 220. The hologram recording system comprises the laser combiner 184 of FIG. 9. The laser combiner 184 outputs a combined beam 198 comprising three different wavelengths 178, 180, 182. The optical system of the hologram recording system 100 of FIG. 10 comprises additional components compared to the hologram recording system 100 of FIG. 1. The optical system comprises a third mirror 222 configured to receive the combined beam 198 and reflect the combined beam 198 to a third beam splitter 224. The third beam splitter 224 is configured to split the combined beam 198 between the first optical device 106 and a fourth mirror 226. The third mirror is configured to reflect the received portion of the combine beam 198 towards the second optical device 108. The first and second optical devices 106, 108 each comprise a periscope system configured to receive the first and second beams 102, 104 respectively. An example of the periscope system is shown in FIG. 11.

FIG. 11 schematically depicts a view from the side of the first optical device of FIG. 10 comprising a periscope system 218. The periscope system 218 comprises a first periscope mirror 228 configured to receive the combined beam 198 and reflect the combined beam 198 towards a second periscope mirror 230. The second periscope mirror 230 is configured to reflect the combined beam 198 towards the lens 110 of the first optical device 106 which then outputs the first beam 102. The periscope system of the second optical device 108 may be substantially identical to the periscope system 218 and the first optical device 106. Use of periscope systems advantageously reduces power instabilities of the first and second beams 102, 104 compared to the use of other systems (such as the optical fibers previously discussed).

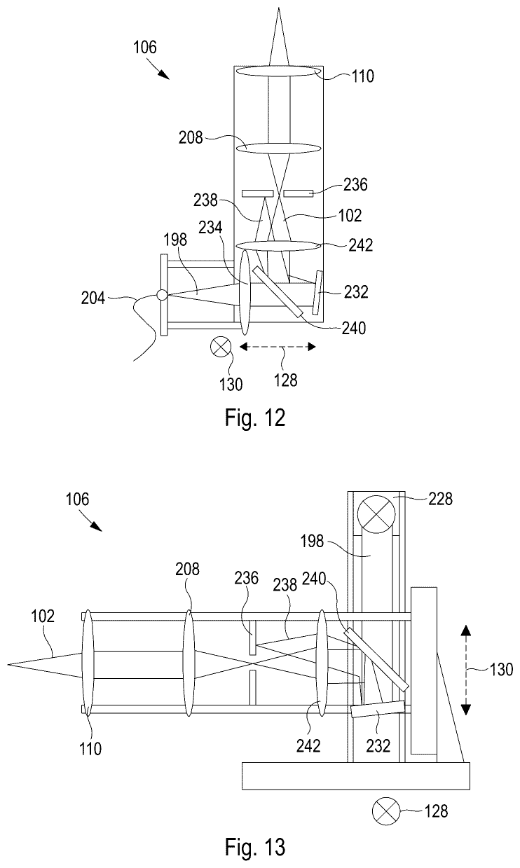

FIG. 12 schematically depicts a first optical device 106 comprising a spatial light modulator 232 according to an embodiment of the present disclosure. In the example of FIG. 12, the first optical device 106 receives a combined beam 198 from an optical fibre 204. The first optical device 106 of FIG. 12 may replace the first optical device 100 of the hologram recording system 100 of FIG. 9. The spatial light modulator 232 is configured to interact with the combined beam 198. Upon entering the first optical device 106, the combined beam 198 is collimated by an eighth lens 234 and is directed towards the spatial light modulator 232. The spatial light modulator 232 may comprise, for example, a liquid crystal, a microoptoelectromechanical system such as, for example, a Digital Micromirror Device™ available from Texas Instruments™ based in the United States of America, etc. . . . The spatial light modulator 232 is configured to diffract the combined beam 198, and thereby spatially modulate the combined beam 198 to form the first beam 102. The spatial light modulator 232 also produces unwanted diffraction orders 238. The first optical device 106 comprises a filtering aperture 236 configured to selectively block at least some of the electromagnetic radiation (i.e. the unwanted diffraction orders 238) diffracted by the spatial light modulator 232. The first beam 102 and the unwanted diffraction orders 238 are incident on a fifth mirror 240 which reflects the first beam 102 and the unwanted diffraction orders 238 to a ninth lens 242. The ninth lens 242 focuses the first beam 102 and the unwanted diffraction orders 238 to the filtering aperture 236. The filtering aperture 236 is configured to block the unwanted diffraction orders 238 from passing through the aperture with the first beam 102. The first beam 102 passes through the filtering aperture 236 and is incident upon the extra lens 208 which collimates the first beam 102 and directs the first beam 102 to the pre-existing lens 110. The pre-existing lens outputs the first beam 102 for use in the hologram recording system. The use of the spatial light modulator 232 advantageously allows the creation of more complex wave fronts due to the spatial modulation of the first beam 102 offered by the spatial light modulator 232. The spatial light modulator 232 advantageously improves discretization of individual hologram elements. That is, edges of the individual hologram elements can be fine-tuned, allowing for the recording of more accurate wavefronts by the hologram recording system. A spatial light modulator 232 may be added to the second optical device.

FIG. 13 schematically depicts a first optical device 106 comprising a spatial light modulator 232 and a periscope system 218 according to an embodiment of the present disclosure. The first optical device 106 of FIG. 13 may replace the optical device of FIG. 10. The combined beam 198 enters the first optical device 106 and is reflected by the first periscope mirror 228 towards a spatial light modulator 232. The spatial light modulator 232 is configured to diffract the combined beam 198, and thereby spatially modulate the combined beam 198 to form the first beam 102. The spatial light modulator 232 also produces unwanted diffraction orders 238. The first optical device 106 comprises a filtering aperture 236 configured to selectively block at least some of the electromagnetic radiation (i.e. the unwanted diffraction orders 238) diffracted by the spatial light modulator 232. The first beam 102 and the unwanted diffraction orders 238 are incident on the fifth mirror 240 which reflects the first beam 102 and the unwanted diffraction orders 238 to a ninth lens 242. The ninth lens 242 focuses the first beam 102 and the unwanted diffraction orders 238 to the filtering aperture 236. The filtering aperture 236 is configured to block the unwanted diffraction orders 238 from passing through the aperture with the first beam 102. The first beam 102 passes through the filtering aperture 236 and is incident upon the extra lens 208 which collimates the first beam 102 and directs the first beam 102 to the pre-existing lens 110. The pre-existing lens outputs the first beam 102 for use in the hologram recording system. The use of the spatial light modulator 232 advantageously allows the creation of more complex wave fronts due to the spatial modulation of the first beam 102 offered by the spatial light modulator 232. The spatial light modulator 232 advantageously improves discretization of individual hologram elements. That is, edges of the individual hologram elements can be fine-tuned, allowing for the recording of more accurate wavefronts by the hologram recording system. A spatial light modulator 232 may be added to the second optical device comprising a periscope system.

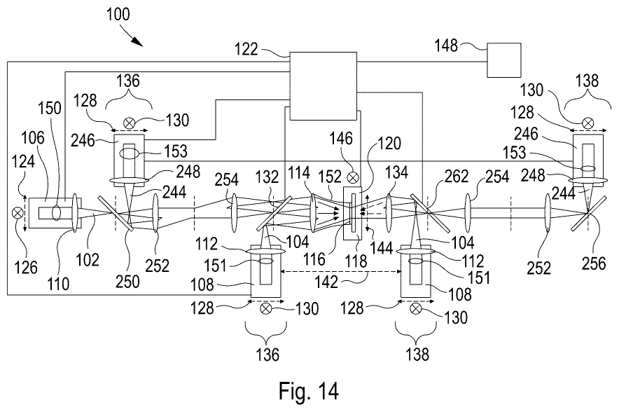

FIG. 14 schematically depicts the hologram recording system 100 of FIG. 1 arranged to perform simultaneous angular-multiplexed and wavelength-multiplexed recording of different holograms on the photosensitive recording medium 116 according to an embodiment of the present disclosure. The optical system of the hologram recording system 100 is configured to provide a third beam of electromagnetic radiation 244. In the example of FIG. 14, a third optical device 246 is configured to provide the third beam 244. The third optical device 246 may be substantially identical to the first and second optical devices 106, 108. The third optical device 246 comprises a third aperture 153 having a variable size. The third optical device 246 comprises a tenth lens 248 configured to focus the third beam 244 upon exiting the third optical device 246.

Like the second optical device, 108, the actuation system 122 is configured to move the third optical device 246 between a transmission hologram recording configuration 136 in which the third beam interacts with the first lens 114, and a reflective hologram recording configuration 138 in which the third beam 244 interacts with the second lens 134. In the transmissive configuration 136, the third beam 244 exits the third optical device 246 and is incident upon a primary beam splitter 250. The primary beam splitter 250 is configured to reflect the third beam 244 and transmit this first beam 102. The first and third beams 102, 244 are incident upon a primary lens 252. The primary lens 252 is configured to collimate the first and third beams 102, 244 and direct the first and third beams 102, 244 to a secondary lens 254. The secondary lens 254 focuses the first and third beams 102, 244 to the beam splitter 132. The primary and secondary lenses 252, 254 may form a 4F relay. The beam splitter 132 transmits the first and third beams 102, 244 whilst reflecting the second beam 104 received from the second optical device 108. The first, second and third beams 102, 104, 244 are incident upon and interact with the first lens 114. The first, second and third beams 102, 104, 244 are directed to the photosensitive recording medium 116 where they interfere with each other and form interference patterns that correspond to recorded holograms. The actuation system 122 is configured to move one or more components of the optical system to adjust positions of the first, second and third beams 102, 104, 244 relative to the first lens 114 and thereby control an angle of incidence of the first, second and third beams 102, 104, 244 at the photosensitive recording medium 116.

In the reflective configuration 138, the third beam 244 exits the third optical device 246 and is incident upon a primary mirror 256. The primary mirror 256 is configured to reflect the third beam 244 towards a primary lens 252. The primary lens 252 is configured to collimate the third beam 244 and direct the third beam 244 to a secondary lens 254. The secondary lens 254 focuses the third beam 244 to a fourth beam splitter 262. The primary and secondary lenses 252, 254 may form a 4F relay. The fourth beam splitter 262 transmits the third beam 244 whilst reflecting the second beam 104 received from the second optical device 108. The second and third beams 104, 244 are incident upon and interact with the second lens 134. The second and third beams 104, 244 are directed to the photosensitive recording medium 116 where they interfere with each other and form interference patterns. The actuation system 122 is configured to move one or more components of the optical system to adjust positions of the first, second and third beams 102, 104, 244 relative to the first and second lenses 134 and thereby control an angle of incidence of the first, second and third beams 102, 104, 244 at the photosensitive recording medium 116.

The first beam 102 may comprise a first wavelength of electromagnetic radiation. The third beam 244 may comprise a second wavelength of electromagnetic radiation. The second beam 104 may comprise the first and second wavelengths of electromagnetic radiation, such that the hologram recording system is configured to perform simultaneous wavelength-multiplexed recording of different holograms on the photosensitive recording medium 116. The second optical device 108 may be in the transmissive hologram recording configuration 136 recording hologram elements with the first beam 102 whilst the third optical device 246 is in the reflective hologram recording configuration 138 recording hologram elements with the first beam 102. The second optical device 108 may be in the reflective hologram recording configuration 138 recording hologram elements with the first beam 102 whilst the third optical device 246 is in the transmissive hologram recording configuration 136 recording hologram elements with the first beam 102. The hologram recording system of the present disclosure may include more than three beams of electromagnetic radiation and/or more than three optical devices configured to output said beams and/or more than the three wavelengths of electromagnetic radiation. The number of beams used, wavelengths used and/or angles of incidence used may be selected in at least partial dependence on the number wavelength-multiplexed and/or angular-multiplexed holograms are desired to be recorded on the photosensitive recording medium.

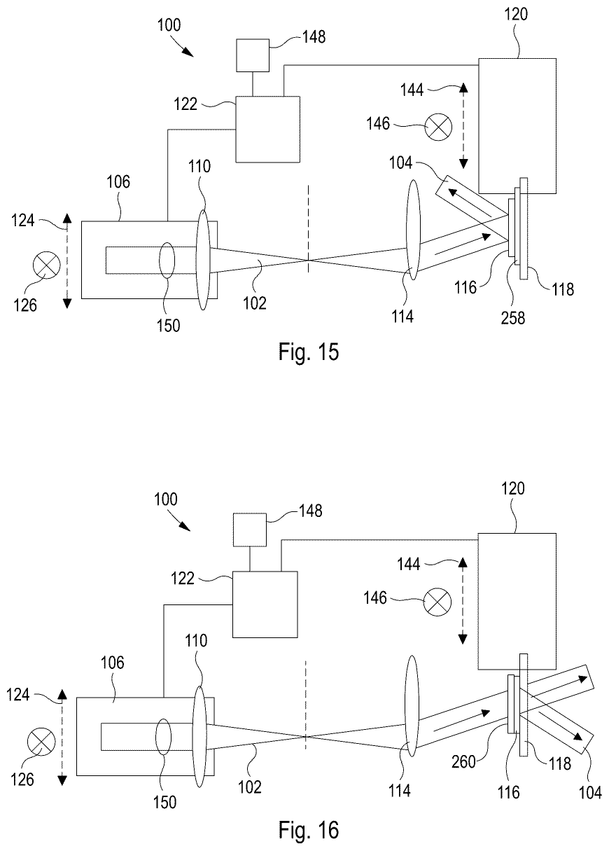

FIG. 15 schematically depicts the holographic recording system 100 of FIG. 1 arranged to record holograms based on a reflective master hologram recording 258 according to an embodiment of the present disclosure. The optical system of the hologram recording system 100 comprises a reflective master hologram recording 258 configured to receive the first beam 102 provided by the first optical device 106 and diffract the first beam 102 to form the second beam 104. The photosensitive recording medium 116 is mounted on the reflective master hologram recording 258 such that the first beam 102 passes the photosensitive recording medium 116 to reach the reflective master hologram recording 258. The first and second beams 102, 104 interfere with each other and form an interference pattern on the photosensitive recording medium 116. The interference pattern formed by the first and second beams 102, 104 is a replication of the interference pattern of the master hologram recording 258. In the example of FIG. 15 the master hologram recording 258 is reflective. However, a transmissive master hologram recording may be used in a different configuration.

FIG. 16 schematically depicts the holographic recording system 100 of FIG. 1 arranged to record holograms based on a transmissive master hologram recording 260 according to an embodiment of the present disclosure. The optical system of the hologram recording system 100 comprises a transmissive master hologram recording 260 configured to receive the first beam 102 provided by the first optical device 106 and diffract the first beam 102 to form the second beam 104. The reflective master hologram recording 258 is mounted on the photosensitive recording medium 116 such that the first beam 102 transmits through the transmissive master hologram recording 260 to reach the reflective photosensitive recording medium 116. The first and second beams 102, 104 interfere with each other and form an interference pattern on the photosensitive recording medium 116. The interference pattern formed by the first and second beams 102, 104 is a replication of the interference pattern of the master hologram recording 258.

When diffracting light, such as diffraction from the master holograms of FIGS. 15 and 16, the light diffracts most efficiently at angle at which the Bragg condition is satisfied. In both FIG. 15 and FIG. 16, the controller 148 is configured to control the actuation system 122 to adjust the position of the first beam 102 relative to the first lens 114 (e.g. by moving the first optical element 106) and thereby control the angle or angles at which the Bragg condition is satisfied for the recorded hologram.

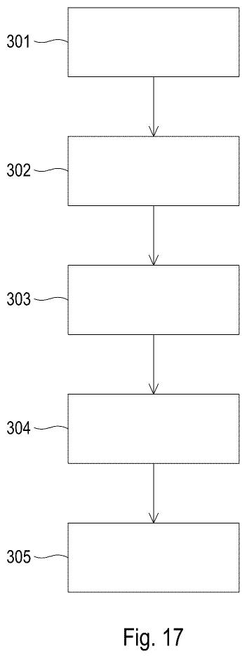

FIG. 17 shows a flowchart of a method of recording a hologram according to an aspect of the present disclosure. The method comprises a first step 301 of using an optical system to provide first and second beams of electromagnetic radiation. The method comprises a second step 302 of using a first lens of the optical system to interact with the first beam. The method comprises a third step 303 of receiving the first and second beams at a photosensitive recording medium. The method comprises a fourth step 304 of controlling an angle of incidence of the first beam at the photosensitive medium by moving a component of the optical system to adjust a position of the first beam relative to the first lens. The method comprises a fifth step 305 of recording an interference pattern formed by the first and second beams at the photosensitive recording medium.

Embodiments of the present disclosure can be employed in many different applications including flat optics, freeform optics, beam-shaping, for example, in augmented reality, virtual reality, automotive, imaging and other industries.

The skilled person will understand that in the preceding description and appended claims, positional terms such as ‘above’, ‘along’, ‘side’, etc. are made with reference to conceptual illustrations, such as those shown in the appended drawings. These terms are used for ease of reference but are not intended to be of limiting nature. These terms are therefore to be understood as referring to an object when in an orientation as shown in the accompanying drawings.

Although the disclosure has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in any embodiments, whether alone or in any appropriate combination with any other feature disclosed or illustrated herein.

1-25. (canceled)

26. A hologram recording system comprising:
an optical system configured to provide first and second beams of electromagnetic radiation, the optical system comprising a first lens configured to interact with the first beam;
a photosensitive recording medium configured to receive the first and second beams and record an interference pattern formed by the first and second beams; and,
an actuation system configured to move a component of the optical system to adjust a position of the first beam relative to the first lens and thereby control an angle of incidence of the first beam at the photosensitive recording medium;
wherein the first lens is configured to interact with the second beam, and wherein the actuation system is configured to move a second component of the optical system to adjust a position of the second beam relative to the first lens and thereby control an angle of incidence of the second beam at the photosensitive recording medium.

27. The hologram recording system of claim 26, wherein the optical system comprises a first optical device configured to output the first beam, wherein the actuation system is configured to move the first optical device to adjust the position of the first beam relative to the first lens and thereby control the angle of incidence of the first beam at the photosensitive recording medium.

28. The hologram recording system of claim 26, wherein the optical system comprises a second optical device configured to output the second beam, and wherein the actuation system is configured to move the second optical device to adjust the position of the second beam relative to the first lens and thereby control the angle of incidence of the second beam at the photosensitive recording medium.

29. The hologram recording system of claim 26, wherein the optical system comprises a beam splitter configured to:
receive the first beam from the first optical device;
transmit the first beam towards the first lens;
receive the second beam from the second optical device; and,
reflect the second beam towards the first lens, wherein the actuation system is configured to move the beam splitter to adjust the position of the second beam relative to the first lens and thereby control the angle of incidence of the second beam at the photosensitive recording medium.

30. The hologram recording system of claim 26, wherein the optical system is configured to converge or diverge at least one of the first and second beams towards the photosensitive recording medium and thereby illuminate the photosensitive recording medium across a plurality of angles.

31. The hologram recording system of claim 26, wherein the actuation system is configured to move the photosensitive recording medium relative to the first and second beams such that the hologram recording system is configured to record a plurality of individual hologram elements on different portions of the photosensitive recording medium.

32. The hologram recording system of claim 31, comprising a controller configured to:
receive a wavefront; and,
control the actuation system such that the plurality of individual hologram elements form a hologram of the wavefront.

33. The hologram recording system of claim 32, wherein the wavefront is a freeform wavefront.

34. The hologram recording system of claim 31, comprising first and second apertures having variable sizes, the first and second apertures being configured to selectively block at least some of the first and second beams and thereby control a size of the individual hologram elements.

35. The hologram recording system of claim 26, wherein the first beam and the second beam comprise a plurality of different wavelengths of electromagnetic radiation such that hologram recording system is configured to perform wavelength-multiplexed recording of holograms on the photosensitive recording medium.

36. The hologram recording system of claim 26, comprising an optical fiber configured to transmit the first and second beams from an electromagnetic radiation source to the optical system.

37. The hologram recording system of claim 35, wherein the first and second optical devices each comprise a periscope system configured to receive the first and second beams.

38. The hologram recording system of claim 26, comprising an immersion fluid configured to increase a numerical aperture of the first lens.

39. The hologram recording system of claim 26, wherein the optical system comprises a spatial light modulator configured to interact with at least one of the first and second beams.

40. The hologram recording system of claim 39, wherein the spatial light modulator is configured to diffract incident electromagnetic radiation, and wherein the optical system comprises a filtering aperture configured to selectively block at least some electromagnetic radiation diffracted by the spatial light modulator.

41. The hologram recording system of claim 26, wherein:
the optical system is configured to provide a third beam of electromagnetic radiation;
the first lens is configured to interact with the third beam;
the photosensitive recording medium is configured to receive the third beam and record an interference pattern formed by the third beam and at least one of the first beam and the second beam;
the actuation system is configured to move a second component of the optical system to adjust a position of the third beam relative to the first lens and thereby control an angle of incidence of the third beam at the photosensitive recording medium; and,
the first beam comprises a first wavelength of electromagnetic radiation, the third beam comprises a second wavelength of electromagnetic radiation, and the second beam comprises the first and second wavelengths of electromagnetic radiation, such that the hologram recording system is configured to perform simultaneous wavelength-multiplexed recording of holograms on the photosensitive recording medium.

42. The hologram recording system of claim 26, wherein:
the optical system is configured to provide a third beam of electromagnetic radiation;
the first lens is configured to interact with the third beam;
the photosensitive recording medium is configured to receive the third beam and record an interference pattern formed by the third beam and at least one of the first beam and the second beam;
the actuation system is configured to move a second component of the optical system to adjust a position of the third beam relative to the first lens and thereby control an angle of incidence of the third beam at the photosensitive recording medium;
the first, second and third beams comprise a first wavelength of electromagnetic radiation; and,
the actuation system is configured to introduce a difference between the angle of incidence of the first beam and the angle of incidence of the third beam such that the hologram recording system is configured to perform simultaneous angular-multiplexed recording of holograms on the photosensitive recording medium

43. The hologram recording system of claim 26, wherein the optical system comprises a master hologram recording configured to receive the first beam and diffract the first beam to form the second beam.

44. The hologram recording system of claim 43, comprising a controller configured to control the actuation system to adjust the position of the first beam relative to the first lens and thereby control a local Bragg condition in a recorded hologram.

45. A hologram recording system comprising:
an optical system configured to provide first and second beams of electromagnetic radiation, the optical system comprising a first lens configured to interact with the first beam;
a photosensitive recording medium configured to receive the first and second beams and record an interference pattern formed by the first and second beams; and,
an actuation system configured to move a component of the optical system to adjust a position of the first beam relative to the first lens and thereby control an angle of incidence of the first beam at the photosensitive recording medium;
wherein the optical system comprises a second lens configured to interact with the second beam, wherein the photosensitive recording medium is positioned between the first lens and the second lens,
wherein the optical system comprises a second optical device configured to output the second beam, and wherein the actuation system is configured to move the second optical device to adjust the position of the second beam relative to the second lens and thereby control the angle of incidence of the second beam at the photosensitive recording medium.

46. A hologram recording system comprising:
an optical system configured to provide first and second beams of electromagnetic radiation, the optical system comprising a first lens configured to interact with the first beam;
a photosensitive recording medium configured to receive the first and second beams and record an interference pattern formed by the first and second beams; and,
an actuation system configured to move a component of the optical system to adjust a position of the first beam relative to the first lens and thereby control an angle of incidence of the first beam at the photosensitive recording medium;
wherein the optical system comprises:
a first optical device configured to output the first beam;
a second optical device configured to output the second beam;
a beam splitter configured to receive the first beam from the first optical device and transmit the first beam towards the first lens;
a second lens configured to interact with the second beam; and,
a mirror, wherein the photosensitive recording medium is positioned between the first lens and the second lens and wherein the actuation system is configured to move the second optical device between:
a transmissive hologram recording configuration in which the beam splitter reflects the second beam towards the first lens; and,
a reflective hologram recording configuration in which the mirror reflects the second beam towards the second lens.

47. The hologram recording system of claim 46, wherein the actuation system is configured to move the beam splitter out of a beam path of the first beam when the second optical device is in the reflective hologram recording configuration.
